(19) United States
(12) Patent Application Publication
(10) Pub. No.: US 2007/0153023 A1
(43) Pub. Date: Jul. 5, 2007

(54) System and method of temporal anti-aliasing

(75) Inventor: Brett Chladny, Plano, TX (US)

Correspondence Address: PILLSBURY WINTHROP SHAW PITTMAN, LLP, P.O. BOX 10500, MCLEAN, VA, 22102, US

(73) Assignee: Computer Associates Think, Inc., Islandia, NY (US)

(21) Appl. No.: 11/324,249

(22) Filed: Jan. 4, 2006

(51) Int. Cl. G09G 5/00

(52) U.S. Cl. 345/611

(57) ABSTRACT

A system and method for temporally anti-aliasing a display of a set of frames rendered from scene information without significantly increasing an amount of processing power used in rendering the frames. In some embodiments of the invention, a view used to render the frames from the scene information may be modulated between renderings of successive frames. This modulation of the view may temporally blend pixel colors displayed in pixels at or near color transitions in the frames by causing the pixel colors of these pixels to fluctuate between frames, thereby reducing aliasing present at these transitions as the human eye observing the display of the frames innately averages the fluctuating pixel colors.

### FIELD OF THE INVENTION

The invention relates to anti-aliasing image frames for digital display.

### BACKGROUND OF THE INVENTION

Generally, displays of digital images may suffer from a phenomenon known as “pixilation,” or “aliasing,” wherein the individual pixels within an image are visible to the naked eye. One typical manifestation of aliasing is that curved objects and diagonal lines within an image may be given an unnatural “stair step” appearance.

A solution to aliasing may include increasing the resolution of the digital images. However, this typically may require a relatively large amount of processing capability, which may necessitate the addition of hardware to an overall system rendering and/or displaying the digital images.

Another solution may include anti-aliasing digital images. However, similarly to increasing resolution, anti-aliasing digital images also typically requires an increased amount of processing power and generally requires the addition of hardware (e.g., a more powerful graphics card) to a computing system.

These and other drawbacks associated with aliasing in digital images and conventional solutions thereto are known.

### SUMMARY

One aspect of the invention relates to a system and method for temporally anti-aliasing a display of a set of frames rendered from scene information without significantly increasing an amount of processing power used in rendering the frames. In some embodiments of the invention, a view used to render the frames from the scene information may be modulated between renderings of successive frames. This modulation of the view may temporally blend pixel colors displayed in pixels at or near color transitions in the frames by causing the pixel colors of these pixels to fluctuate between frames, thereby reducing aliasing present at these transitions as the human eye observing the display of the frames innately averages the fluctuating pixel colors.

In some embodiments of the invention, a system for anti-aliasing a set of digital frames for display may include an scene information storage, a processor, a display device, an input device, and/or other components. In some embodiments of the embodiments, the system may be realized as a single device or apparatus (e.g., a personal desktop computer, a personal laptop computer, a handheld electronic device, etc.). The system may provide anti-aliasing to digital frames displayed on display device by modulating a view (e.g., modulating one or more parameters of a view frustum, modulating one or more parameters of a field of view determined according to a view frustum, etc.) used to render the frames. As the view is modulated, the pixels in the display device at or near color transitions in the frames may display different ones of the colors from the color transitions, which may anti-alias the frames by causing the color transitions to become blurred in the perception of an individual viewing the display.

According to various embodiments of the invention, anti-aliasing frames by modulating a view used to render the frames may introduce visual artifacts into the display of the frames. In these instances, the implementation of the temporal anti-aliasing may be designed to strike a balance between the benefits received via the temporal anti-aliasing and the detraction from the quality of the display of the rendered frames due to artifact introduction. Various phenomena (e.g., frame rate of a display device, rate of motion of objects within the frames, rotation or movement of the view, etc.) may exacerbate artifact introduction during modulation of the view for temporal anti-aliasing. In some embodiments, enablement of this temporal anti-aliasing via modulation may be based on detection of one or more phenomena related to the introduction of visual artifacts by the anti-aliasing. For example, the anti-aliasing may be automatically enabled (or disabled) based on the automatic detection of the phenomena related to artifact introduction. In other embodiments, the anti-aliasing may be manually enabled or disabled by an individual. In these embodiments, suggestions may be automatically provided to the individual as to whether or not the anti-aliasing should be enabled. The suggestions may be made based on the automatic detection of the phenomena related to artifact introduction.

In some embodiments of the invention, one or more anti-aliasing settings may be adjusted to adjust the amount of anti-aliasing provided to frames by modulating a view used to render the frames. For example, an offset amount (e.g., a fractional portion of a pixel to shift the view), an offset direction (e.g., a direction in which to shift the view), an anti-aliasing mode, or other settings may be adjusted. The settings may be adjusted to strike a balance between the benefits received via the anti-aliasing and the detraction from the quality of the display of the rendered frames due to artifact introduction. In some instances, the adjustment of one or more anti-aliasing settings may be done automatically based on the detection of one or more of the above-mentioned phenomena related to artifact introduction. In some instances, the adjustment of one or more anti-aliasing settings may be done manually by an individual. In these instances, suggestions regarding the adjustment of the anti-aliasing settings may be provided to the individual based on the automatic detection of the phenomena related to artifact introduction.

### BRIEF DESCRIPTION OF THE DRAWINGS

FIG. 1 illustrates a system for anti-aliasing a set of digital frames for display, in accordance with some embodiments of the invention.

FIG. 2 illustrates a method of anti-aliasing a set of digital frames for display, according to some embodiments of the invention.

FIG. 3A illustrates a view of a scene, in accordance with some embodiments of the invention.

FIG. 3B illustrates modulating a view of a scene, in accordance with some embodiments of the invention.

FIG. 3C illustrates modulating a view of a scene, according to some embodiments of the invention.

FIG. 4 illustrates a method of anti-aliasing a set of digital frames for display, according to some embodiments of the invention.

### DETAILED DESCRIPTION

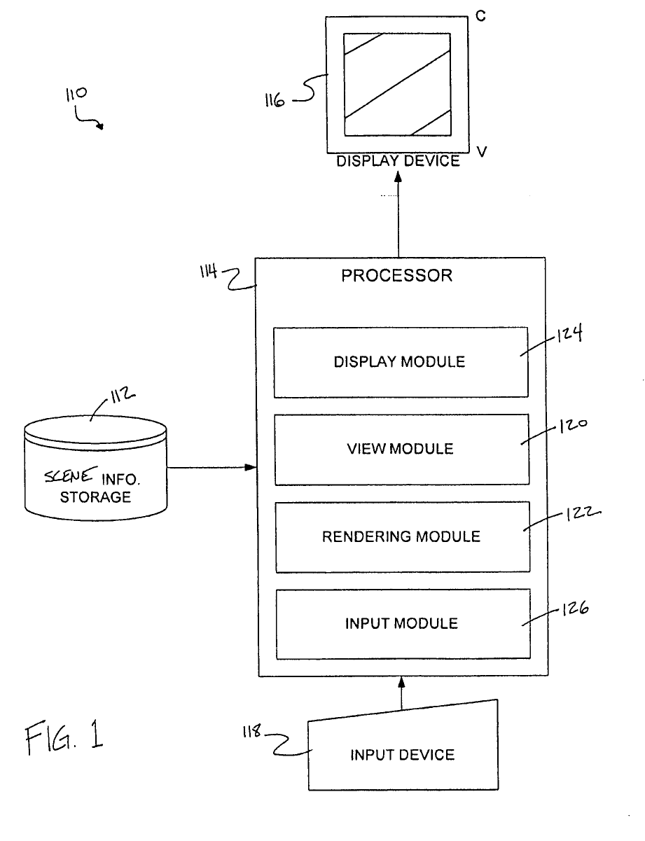

FIG. 1 is an exemplary illustration of a system 110 for anti-aliasing a set of digital frames for display in accordance with some embodiments of the invention. System 110 may include an scene information storage 112, a processor 114, a display device 116, an input device 118, and/or other components. In certain embodiments of the invention, system 110 may be realized as a single device or apparatus (e.g., a personal desktop computer, a personal laptop computer, a handheld electronic device, etc.). In other embodiments, one or more of the various components 112, 114, 116, and 118 of system 110 may be physically and/or operationally distinct from other ones of components 112, 114, 116, and 118 of system 110, with communication links enabling information to be exchanged therebetween. System 110 may provide anti-aliasing to digital frames displayed on display device 116 by modulating a view used to render the frames from scene information such that pixel colors displayed in pixels at or near color transitions in the frames may be temporally blended by causing the pixel colors of these pixels to fluctuate between frames, thereby reducing the amount of aliasing present at these transitions as the human eye observing the display of the frames innately averages the fluctuating pixel colors.

According to various embodiments of the invention, display device 116 may include a digital display device capable of displaying a rendered frame of scene information to one or more individuals. For example, display device 116 may include a liquid crystal display, a micro-mirror display, a plasma display, a cathode-ray tube display, and/or other displays. In some embodiments, display device 116 may be integrated into the same overall device as other components of system 110 (e.g., the display panel of a handheld device). In other embodiments, display device 116 may “stand alone” (e.g., a separate computer monitor).

In some embodiments of the invention, input device 118 may enable an individual to input information to system 110. For example, input device 118 may include one or more of a knob, a button, a switch, a keyboard, a mouse, joystick, a trackball, a microphone, a lever, a pedal, a key, a key pad, a touch-screen, a touch-pad, and/or other devices that enable information to be input to system 110. In some instances, input device 118 and display device may be integral to each other (e.g., a touch screen, a graphical user interface, etc.). In some embodiments, input device 118 may be integrated into the same overall device as other components of system 110 (e.g., the touch-screen and/or keypad of a handheld device). In other embodiments, display device may include one or more “stand alone” devices that are separate and distinct from the rest of system 110 (e.g., a keyboard, a mouse, etc.).

Scene information storage 112 may store scene information associated with a scene (e.g., a three-dimensional scene), which may be used to render frames for display on display device 116. In some embodiments of the invention, the scene information may include geometric information related to the position(s) of one or more polygons within the scene, texture information related to textures applied to the polygon(s) within the scene, lighting/shading information related to lighting and/or shading of the polygon(s) within the scene, and/or other information associated with the scene. In such embodiments, the frames may be rendered from the scene information to depict images of the scene. The geometric volume of the scene depicted in a frame for display may be called the view of that frame. The view may be include a field of view of the scene determined according to a view frustum. In other embodiments, the scene information storage 112 may store information associated with other types of digital images such as, for example, two-dimensional images, text images, or other images. Scene information storage 112 may include any suitable machine readable storage medium for storing digital information, or other information, associated with images to be displayed on display device 116.

According to various embodiments of the invention, scene information storage 112 may be operatively linked with processor 114. The operative link between scene information storage 112 and processor 114 may include a wired link, a wireless link, a link over a network, a link via a dedicated line, or other communications links. Processor 114 may receive scene information from scene information storage 112 and render frames for display from the received information. Although processor 114 is shown in FIG. 1 is a single unit, it may be appreciated that processor 114 may include a plurality of processors operatively linked to each other, and that various ones of the linked processors may be physically located locally to each other, or may be remote from each other. For example, in one embodiment, processor 114 may include a central processing unit associated with a personal computer and one or more ancillary processing units within the personal computer (e.g., a graphics card, etc.). In another embodiment, processor 114 may include a processing unit (or processing units) associated with a handheld device, such as a personal digital assistant (“PDA”), a portable telephone, a handheld computer, or another handheld device.

In some embodiments of the invention, processor 114 may execute a view module 120, a rendering module 122, a display module 124, an input module 126, and/or other modules. Each of modules 120, 122, 124, and 126 may be implemented in hardware, software, firmware, or in some combination thereof. Modules 120, 122, 124, and 126 may be executed locally to each other, or one or more of modules 120, 122, 124, and 126 may be executed remotely from other ones of modules 120, 122, 124, and 126.

In some embodiments, view module 120 may determine the view to be used in the rendering of one or more frames from the scene information received from scene information storage 112. For example, determining the view may include determining the view frustum and/or determining the field of view of the scene (e.g., from the view frustum) to be used in the rendering of one or more frames from the scene information received from scene information storage 112. Determining the view frustum may include determining the position and rotational orientation of the view frustum in the scene. Determining the field of view may include determining a portion of an image plane of the scene to be rendered in generating a frame of the scene.

According to various embodiments of the invention, rendering module 122 may render the set of frames in accordance with the view determined by view module 120. Rendering a frame may include determining a pixel color for each pixel in the frame. The determination of a pixel color of a pixel may be based on the color at the center of a pixel, as determined from the scene information associated with the scene being rendered. Thus, it should be appreciated that if the view used to render frames from the scene information is modulated between frames, the color associated with the scene information associated with the center of a given pixel according to the view may also be modulated. This modulation of the color at the center of the pixel may cause the pixel color of the pixel to fluctuate even when the scene information corresponds to a static image of the scene.

In some embodiments of the invention, display module 124 may provide the frames rendered by rendering module 122 to display device 116 for display. The rendered frames may be provided to display device 116 via an operative link between display device 116 and processor 112. The operative link between display device 116 and processor 114 may include a wired link, a wireless link, a link over a network, a link via a dedicated line, or other communications links.

According to various embodiments of the invention, input module 126 may receive input from input device 118. As will be discussed further below, the input received by input module 126 may be enable an individual to adjust, control, configure, and/or otherwise manipulate various settings related to the functionality of system 110. The input received by input module 126 from input device 118 may be received via an operative link between input device 118 and processor 112. The operative link between input device 118 and processor 114 may include a wired link, a wireless link, a link over a network, a link via a dedicated line, or other communications links.

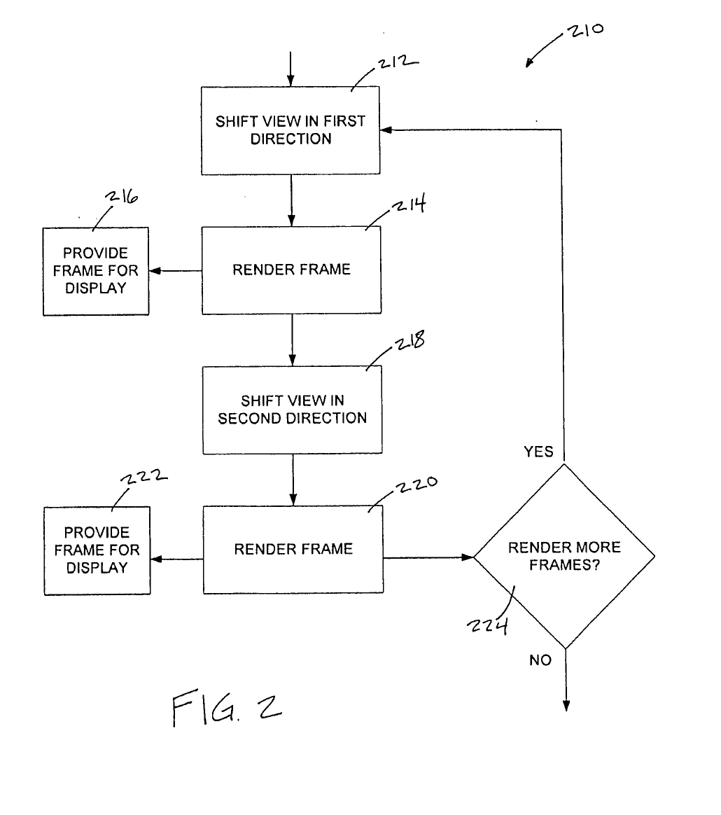

FIG. 2 is an exemplary illustration of a method 210 of modulating a view used to render a set of digital frames for display in order to provide anti-aliasing to the rendered frames, in accordance with some embodiments of the invention. In some embodiments, various operations within method 210 may be implemented and/or executed by system 110. However, these embodiments are not limiting, and other embodiments exist in which various operations included in method 210 may be implemented and/or executed by components not shown or described as being a part of system 110.

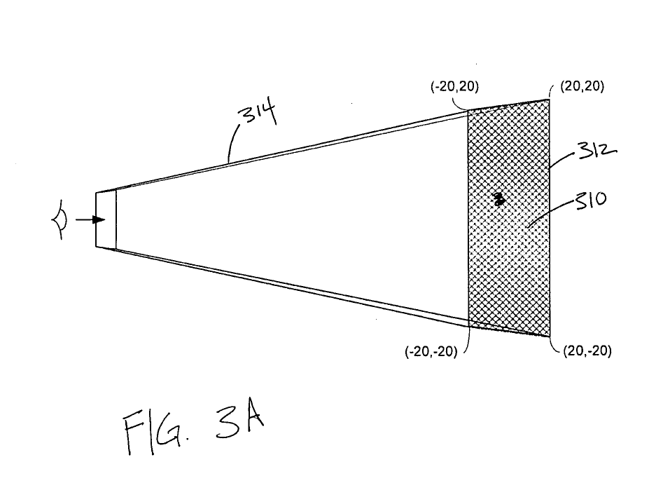

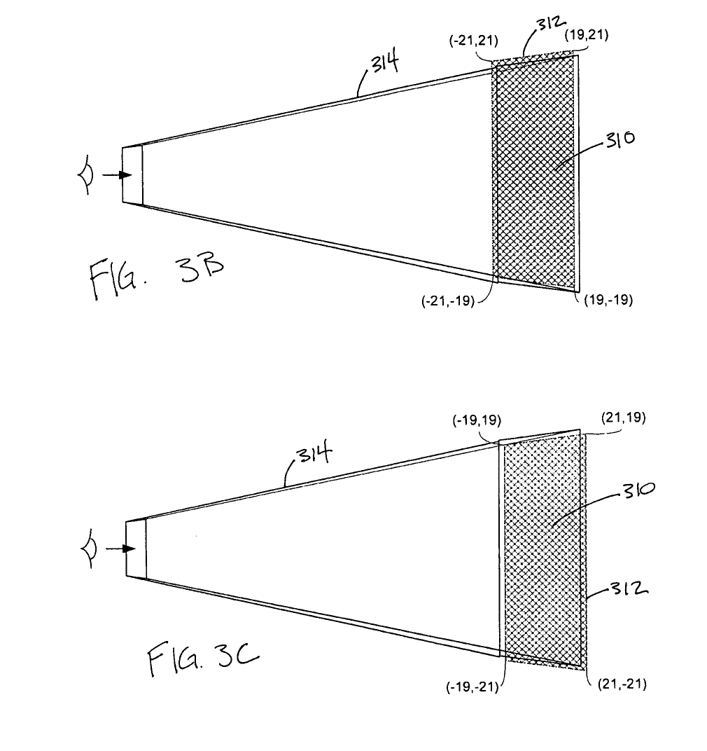

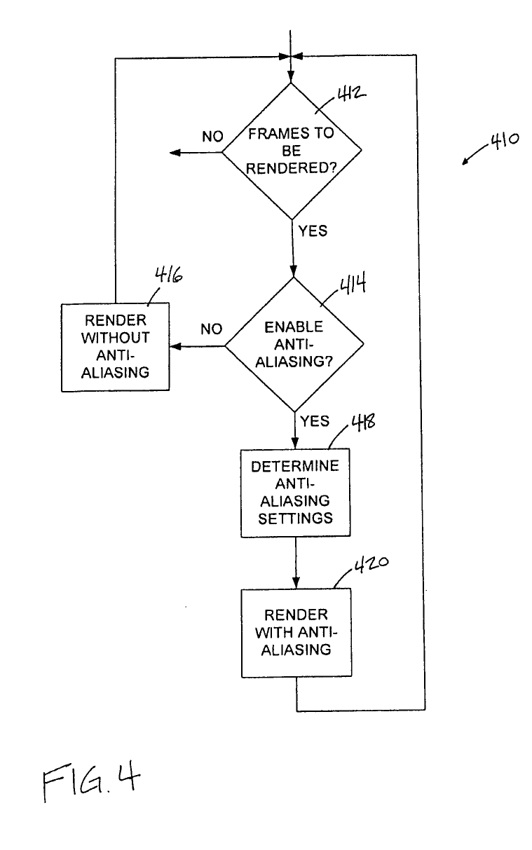

At an operation 212 one or more parameters of a view (e.g., a view frustum, a field of view determined according to a view frustum, etc.) of a scene (e.g., a three-dimensional scene) may be modulated such that the view of the scene included in the rendered frames of the scene may be shifted from a default configuration within the scene. For example, FIG. 3A graphically illustrates a rendered image plane 310 of a scene associated with stored scene information. The parameters (e.g., location, dimensions, etc.) of a field of view 312 that bounds rendered image plane 310 may be determined according to a view frustum 314. In FIG. 3A, field of view 312 may include an area that is 40×40 (of an arbitrary unit of distance) and, thus, the corners of field of view 312 may be positioned at the coordinate positions enumerated in FIG. 3A (where the center of image plane 310 bounded by field of view 312 is assigned as the origin (0,0) of the coordinate system).

FIG. 3B illustrates one manner of modulating one or more parameters of the view of the scene that may be employed to shift the view from the default configuration illustrated in FIG. 3A. More particularly, one or more parameters of field of view 312 may be modulated such that the portion of image plane 310 bounded by field of view 312 (e.g., the portion of the scene to be rendered) determined according to view frustum 314 is shifted from the default configuration. In FIG. 3B, this shift may include the shift between the portion of image plane 310 intersected by view frustum 314 and the portion of image plane 310 bounded by field of view 312. The direction and magnitude of the shift of the portion of image plane 310 bounded by field of view 312 (e.g., the shift exemplified by the change in the coordinates of the corners of field of view 312 between FIGS. 3A and 3B) may be referred to as the offset direction and the offset amount, respectively.

The modulation of one or more parameters of the view illustrated in FIGS. 3A and 3B may cause the scene information at one or more of the pixels in the view located in the scene at or near color transitions to change so as to alter pixel colors of some of the pixels. In some instances, the offset amount may be a fractional amount of a pixel size of the pixels of the frame(s) rendered from the stored scene information. For example, the offset amount may be ¼ pixel, ½ pixel, ⅓ pixel, or another fractional amount of a pixel size. In some embodiments of the invention, operation 212 may be executed by view module 120.

Returning to FIG. 2, at an operation 214 a frame may be rendered according to the shifted view (i.e., the view shifted at operation 212). In some embodiments, operation 214 may be executed by rendering module 122.

At an operation 216 the rendered frame from operation 214 may be provided for display. In some embodiments, the rendered frame may be provided by display module 124 for display on display device 116.

At an operation 218 the one or more parameters of the view may again be modulated. In some embodiments of the invention, the one or more parameters may modulated to shift the view from the default configuration in a second offset direction by a second offset amount. For example, FIG. 3C illustrates field of view 312 shifted from the default configuration of FIG. 3A in an offset direction opposite from the offset direction illustrated in FIG. 3B. As with the first offset amount, the second offset amount may include a fractional amount of the size of a single pixel. In some instances, the second offset direction may be the opposite direction from the offset direction used in operation 212 and the second offset amount may be equal to the offset amount used in operation 212 (e.g., as illustrated in FIGS. 3B and 3C). Other offset directions and offset amounts may be used.

In other embodiments, the modulation of the one or more parameters of the view at operation 218 may result in shifting the view from the shifted view determined in operation 212 in a second offset direction by a second offset amount. As a non-limiting example, the shift of the view at operation 218 may shift the view from the shifted view determined in operation 212 back to the default configuration. In some embodiments, operation 218 may be executed by view module 120 shown in FIG. 1.

Referring to FIG. 2, at an operation 220 a frame may be rendered according to the view with the one or more parameters provided by operation 218 (e.g., the frame may include the portion of the image plane bounded by a shifted field of view, as illustrated in FIGS. 3B and 3C). In some embodiments, operation 220 may be executed by rendering module 122.

At an operation 222 the rendered frame from operation 220 may be provided for display. In some embodiments, the rendered frame may be provided by display module 124 for display on display device 116.

At an operation 224, a determination may be made as to whether more frames are to be rendered using the current anti-aliasing settings. The determination may be based on whether more frames are going to be displayed, whether one or more anti-aliasing settings has been adjusted, and/or other considerations. If there are more frames to be rendered using the current settings, method 210 may return to operation 212. If there are no more frames to be rendered using the current settings, method 210 may be discontinued.

It may be appreciated that the depiction of method 210 in FIG. 2 is merely exemplary, and that other embodiments of the invention exist for shifting the view used to render successive frames for display in order to temporally blend the pixel colors of pixels at or near color transitions in the frames. For example, in some embodiments, method 210 may include additional operations that shift the view in additional directions to provide additional amounts of anti-aliasing (e.g., shifting in two directions may provide 2× anti-aliasing, shifting in four different directions for four successive frames may provide 4× anti-aliasing, etc.). In other embodiments, the view may be shifted in a first offset direction for one frame, shifted back to the default configuration for the next frame, then shifted in a second offset direction for the frame after that, then back to the default configuration, and so on (for any number of offset directions). In still other embodiments, the offset directions applied to successive frames may be determined randomly (or quasi-randomly).

FIG. 4 is an exemplary illustration of a method 410 of rendering frames for display, in accordance with some embodiments of the invention. In some embodiments, various operations within method 410 may be implemented and/or executed by system 110. However, these embodiments are not limiting, and other embodiments exist in which various operations included in method 410 may be implemented and/or executed by components not shown or described as being a part of system 110.

At an operation 412 a determination may be made as to whether there are frames to be rendered for display. If there are frames to be rendered, then method 410 may proceed to an operation 414. At operation 414, a determination may be made as to whether temporal anti-aliasing should be enabled. It should be appreciated that while temporal anti-aliasing applied by modulating a view used to render frames from scene information may enhance the display of the rendered frames in some conditions, other operating conditions exist in which this approach may introduce visual artifacts into the display. In some instances the artifacts may be more detrimental to the perception of the frames by an individual viewing the display than the aliasing alleviated by the temporal anti-aliasing.

For example, modulating one or more parameters of the view such that the view is shifted in successive frames may effectively modulate the view at the frame rate at which a display device displaying the frames is being refreshed. Consequently, as the frame rate of the display device drops, the modulation of the view, rather than merely serving to temporally blend pixel colors of pixels at or near color transitions, may cause a noticeable flicker that may distract the individual viewing the display device.

As another example, in instances in which the frames depict objects (e.g., polygons in a three-dimensional scene) in motion, as the depicted rate of motion of an object increases, an amount and/or magnitude of visual artifacts (e.g., boundary flicker, etc.) introduced by temporal anti-aliasing within the rendered frames may increase. Other artifacts linked to object motion may also be introduced. For example, in implementations in which the scene information is associated with a three-dimensional scene, rotation of the view frustum (e.g., yaw, pitch, roll, etc.), in conjunction with the modulation of the view, may introduce visual artifacts into the display of the frames.

Another source of visual artifacts may include other anti-aliasing functionality provided by processor 114, when used in conjunction with the temporal anti-aliasing described herein. For example, in some instances processor 114 may include a separate graphics card that provides anti-aliasing by rendering each of the frames of a scene according to a plurality of views (e.g., two views for 2× anti-aliasing, four views for 4× anti-aliasing, etc.), and then for each pixel in a given frame, averaging the pixel colors from each of the different renderings of the frame. In these instances, the different views used to render each of the frames may be determined by shifting the view in a manner similar to the shifting of the view between successive frames to provide temporal anti-aliasing described herein. When this is the case, if the offset amounts and/or offset directions used to determine the views for the anti-aliasing provided by the graphics card are substantially the same as the shifts applied to the view for the temporal anti-aliasing, the temporal anti-aliasing may effectively decrease the amount of anti-aliasing provided by processor 114. However, the offset amounts and/or offset distances of one or both of the anti-aliasing provided by the graphics card and the temporal anti-aliasing may be adjusted (e.g., in the manner discussed further below) to ensure that these offset amounts and/or offset distances are different.

In some embodiments of the invention, in order to avoid these and other visual artifacts, the temporal anti-aliasing may at times be disabled. For example, an individual may manually disable the temporal anti-aliasing. In some embodiments, the individual may manually disable the temporal anti-aliasing being performed by processor 114 via input device 118. As another example, the temporal anti-aliasing may be automatically disabled based on a detection of phenomena that may, in conjunction with the anti-aliasing, introduce visual artifacts into the displayed frames. In some instances, the detection of such phenomena may include a detection of a frame rate that is below a threshold rate (e.g., 60 Hz), a detection of an object shown in the frames moving above a threshold rate, a detection of a threshold amount of rotation of a view frustum between frames, and/or detections of other phenomena that may cause the temporal anti-aliasing to introduce artifacts into the display. In other embodiments, the detection of phenomena that may, in conjunction with the temporal anti-aliasing, introduce visual artifacts into the displayed frames, may trigger a suggestion to an individual viewing the display to manually disable the temporal anti-aliasing. The suggestion may include a visual suggestion and/or an audible suggestion. In some of the embodiments in which phenomena that may cause temporal anti-aliasing to introduce artifacts into the display of the frames are automatically detected, one or more thresholds used to detect the phenomena (e.g., threshold frame rate, threshold motion rate, threshold amount of rotation, etc.) may be manually configured by an individual. As one alternative to manual configuration of the threshold(s) used to detect phenomena that impact the introduction of visual artifacts in the display of the rendered frames, one or more thresholds may be automatically set. Such an automatic configuration may be based in part on one or more capabilities and/or component capabilities of the system in which the anti-aliasing is being applied. For example, a capability may include a graphics card processing speed, a central processing unit speed, an amount of available memory, a display resolution, or other capabilities.

In some embodiments of the invention, if it is determined at operation 414 that anti-aliasing is disabled, frames may be rendered without anti-aliasing at an operation 416. However, if it is determined at operation 414 that anti-aliasing is enabled, method 410 may proceed to an operation 418. At operation 418 one or more settings of the anti-aliasing to be provided to the rendering of the frames may be determined. A setting of the anti-aliasing may include, an offset amount, a number of offset directions, or other settings. For example, in some embodiments, a setting may include a mode of temporal anti-aliasing. Modes of anti-aliasing may include anti-aliasing the frames by modulating the parameters of the view to shift the view used to render successive frames from a default configuration in different offset directions; modulating the parameters of the view to shift the view used to render a first frame from a default configuration in a first offset direction to a first offset position, shift the view back to the default configuration for the next frame, shift the view either back to the first offset position or to a second offset position (the second offset position may be located in a second offset direction from the default configuration) for the following frame, shift the frame back to the default configuration, and so on; modulating the parameters of the view to shift the view used to render successive frames between frame renderings in a randomly (or quasi-randomly) selected offset direction; and/or other modes of anti-aliasing.

As was discussed above, the temporal anti-aliasing may introduce visual artifacts into the display of the set of frames. It may be appreciated that by adjusting the settings, the effectiveness of the temporal anti-aliasing may be enhanced or encumbered, but that the adjustment of the settings to enhance the temporal anti-aliasing may also increase the number and/or magnitude of artifacts introduced by the temporal anti-aliasing. Therefore, the temporal anti-aliasing settings may be adjusted in order to provide a balance of anti-aliasing performance and artifact introduction. It may also be appreciated from the discussion above that various other phenomena may affect the introduction of visual artifacts by the temporal anti-aliasing. For example, as a frame rate of the display device on which the rendered frames are displayed increases, the artifacts introduced by the temporal anti-aliasing may be suppressed. In another non-limiting example, as the rate of movement of objects shown in the frames is decreased, the artifacts introduced by temporal anti-aliasing may be suppressed. Other phenomena may also affect the introduction of visual artifacts into the display of the frames by the temporal anti-aliasing.

In some embodiments of the invention, determining one or more settings of the temporal anti-aliasing at operation 418 may include enabling adjustment of the one or more settings manually by an individual. In some embodiments, the individual may manually adjust one or more settings used by processor 114 in providing temporal anti-aliasing for rendered frames by inputting adjustments via input device 118. In some embodiments in which temporal anti-aliasing settings may be manually adjusted, suggestions may be presented to the individual for making adjustments to the settings. The suggestions may be made based on the detection of one or more phenomena that may impact the introduction of visual artifacts by the temporal anti-aliasing and/or currently implemented temporal anti-aliasing settings. For example, when the frame rate used to display the rendered frames drops below a threshold frame rate, a suggestion may be made to the individual to decrease an amount of temporal anti-aliasing, or otherwise adjust the temporal anti-aliasing settings. Other phenomena may be detected to provide similar suggestions to the individual. The suggestions may include visual suggestions, audible suggestions, or other suggestions.

According to some embodiments of the invention, determining one or more settings of the temporal anti-aliasing at operation 418 may include an automatic determination and/or adjustment of one or more settings of the temporal anti-aliasing. The automatic determination and/or adjustment of the one or more settings may be based on the detection of one or more phenomena that may impact the introduction of visual artifacts into the visual display of the rendered frames. This detection of phenomena may be similar to the detection of phenomena described above for operation 414. In some embodiments of the invention, the settings may be automatically determined by view module 120 of processor 114.

At an operation 420 a set of frames may be rendered with temporal anti-aliasing according to the anti-aliasing settings determined in operation 418. In some embodiments of the invention, the set of frames may be rendered using method 210, discussed previously.

It should be appreciated that method 410, as shown and described herein, is provided for illustrative purposes only, and that method 410 may be implemented with more or less operations, or with the operations re-ordered, without departing from the intended scope of the invention. Additionally, though references are made to polygonal modeling techniques that use perspective projections to render images of a three-dimensional scene. These references are not intended as limiting, and it should be appreciated that the instant invention is applicable to other graphical modeling techniques, including other three-dimensional graphical modeling techniques (e.g., using orthographic projection, parallel view, etc.) and/or two-dimensional graphical modeling techniques.

While the invention has been described herein in terms of various embodiments, it is not so limited and is limited only by the scope of the following claims, as would be apparent to one skilled in the art.

What is claimed is:

1. A method of anti-aliasing a set of frames depicting a scene associated with scene information, the method comprising:
applying a first offset to a view, wherein applying the first offset to the view comprises shifting the view from a default configuration in the scene in a first offset direction by a first offset amount;
rendering a first frame from the scene information with the view shifted by the first offset;
displaying the first frame;
applying a second offset to the view, wherein the applying the second offset to the view comprises shifting the view from the default configuration in a second offset direction by a second offset amount;
rendering a second frame from the scene information with the view shifted by the second offset; and
displaying the second frame.

2. The method of claim 1, wherein the first frame and the second frame are displayed successively.

3. The method of claim 1, wherein the second offset amount is zero.

4. The method of claim 1, wherein one or both of the first offset amount and the second offset amount are automatically determined.

5. The method of claim 1, wherein one or both of the first offset amount and the second offset amount are determined by a user selection.

6. The method of claim 1, wherein the first offset direction is the opposite direction from the second offset direction.

7. The method of claim 1, further comprising:
applying a third offset to a view, wherein applying the third offset to the view comprises shifting the view from the default configuration in a third offset direction by a third offset amount;
rendering a third frame from the scene information with the view shifted by the third offset;
displaying the third frame;
applying a fourth offset to a view, wherein applying the fourth offset to the view comprises shifting the view from the default configuration in a fourth offset direction by a fourth offset amount;
rendering a fourth frame from the scene information with the view shifted by the fourth offset; and
displaying the fourth frame rendered.

8. The method of claim 7, wherein the first frame, the second frame, the third frame, and the fourth frame are displayed successively.

9. The method of claim 7, wherein one or more of the first offset amount, the second offset amount, the third offset amount, or the fourth offset amount are automatically determined.

10. The method of claim 7, wherein one or more of the first offset amount, the second offset amount, the third offset amount, or the fourth offset amount are determined based on a user selection

11. The method of claim 1, wherein the view comprises a view frustum.

12. The method of claim 1, wherein the view comprises a field of view determined according to a view frustum.

13. A system for anti-aliasing a set of frames depicting a scene associated with scene information, the system comprising:
a processor comprising:
a view module that controls a view, and
a rendering module that uses the view to render a set of frames from the scene information,
the view module controlling the view such that a first offset is applied to the view used by the rendering module to render a first subset of frames included in the set of frames and a second offset is applied to the view used by the rendering module to render a second subset of frames included in the set of frames,
wherein applying the first offset to the view comprises shifting the view from a default configuration in the scene in a first offset direction by a first offset amount and applying the second offset to the view comprises shifting the view from the default configuration in a second offset direction by a second offset amount; and
a display that displays the frames rendered by the rendering module.

14. The system of claim 13, wherein the view module controls the view such that frames that are to be displayed consecutively are included in different ones of the first subset of frames and the second subset of frames.

15. The system of claim 13, wherein the second offset amount is zero.

16. The system of claim 13, wherein one or both of the first offset amount and the second offset amount are automatically determined.

17. The system of claim 13, wherein one or both of the first offset amount and the second offset amount are determined based on a user selection.

18. The system of claim 13, wherein the first offset direction is in an opposite direction from the second offset direction.

19. The system of claim 13, wherein the view module controls the view such that a third offset is applied to the view used by the rendering module to render a third subset of digital frames included in the set of digital frames and a fourth offset is applied to the view used by the rendering module to render a fourth subset of digital frames included in the set of digital frames, and wherein applying the third offset to the view comprises shifting the view from the default configuration in a third offset direction by a third offset amount and applying the fourth offset to the view comprises shifting the view from the default configuration in a fourth offset direction by a fourth offset amount.

20. The system of claim 19, wherein one or more of the first offset amount, the second offset amount, the third offset amount, or the fourth offset amount are automatically determined.

21. The system of claim 19, wherein one or more of the first offset amount, the second offset amount, the third offset amount, or the fourth offset amount are determined based on a user selection.

22. The system of claim 13, wherein the view comprises a view frustum.

23. The system of claim 13, wherein the view comprises a field of view determined according to a view frustum.

24. A system for anti-aliasing a set of frames depicting a scene associated with scene information, the system comprising:
a view module that controls a view; and
a rendering module that uses the view to render a set of frames from the scene information,
wherein the view module modulates the view between frames to temporally blend pixel colors of pixels located at or near color transitions in the scene.
